(19) United States
(12) Patent Application Publication
(10) Pub. No.: US 2015/0355112 A1
(43) Pub. Date: Dec. 10, 2015

(54) COMPUTATION APPARATUS, PROGRAM, AND X-RAY IMAGING SYSTEM

(71) Applicant: CANON KABUSHIKI KAISHA, Ohta-ku, Tokyo (JP)

(72) Inventor: Genta Sato, Kawasaki-shi (JP)

(21) Appl. No.: 14/655,686

(22) PCT Filed: Dec. 20, 2013
(86) PCT No.: PCT/JP2013/007506

§ 371 Date: Jun. 25, 2015

(30) Foreign Application Priority Data
Dec. 27, 2012 (JP) 2012-284425
Nov. 20, 2013 (JP) 2013-240121

(51) Int. Cl. G01N 23/04; G21K 1/06; G06F 5/01; G01N 23/20

(52) U.S. Cl. CPC G01N 23/04; G01N 23/20075; G21K 1/067; G06F 5/01; G21K 2201/067

(57) ABSTRACT

A computation apparatus includes a normalization unit configured to normalize values of two of distributions including a distribution of absorption information of a subject, a distribution of phase information of the subject, and a distribution of scattering information of the subject which are calculated by using a projection image of the subject by X-rays, and a calculation unit configured to calculate a difference or quotient of the normalized two distributions and obtain a composite distribution.

### TECHNICAL FIELD

The present invention relates to a computation apparatus that calculates image information by using a projection image of a subject, a computation method, a program, and an X-ray imaging system.

### BACKGROUND ART

An X-ray imaging system is utilized for multiple purposes in a medical diagnosis or a nondestructive inspection. Information of an X-ray projection image is processed through digitalization of a detector developed in recent years to increase a visibility of the image. PTL 1 describes a display in which an absorption image and a phase image of a subject are superposed on each other in an X-ray phase imaging field corresponding to imaging where a phase change of the X-ray based on the subject is utilized. According to this, insufficient information based only on the absorption image is complemented by the phase image, and the visibility of the image can be increased.

### CITATION LIST

### Patent Literature

PTL 1: PCT Japanese Translation Patent Publication No. 2009-525084

### SUMMARY OF INVENTION

### Solution to Problem

A computation apparatus according to an aspect of the present invention includes a normalization unit configured to normalize values of two of distributions including a distribution of absorption information of a subject, a distribution of phase information of the subject, and a distribution of scattering information of the subject which are calculated by using a projection image of the subject by X-rays, and a calculation unit configured to calculate a difference or quotient of the normalized two distributions and obtain a composite distribution.

### Advantageous Effects of Invention

According to the embodiments of the present invention, it is possible to provide the computation apparatus with which the decrease in the visibility of the image caused by the influence from the surrounding signal can be alleviated, the computation method, the program, and the X-ray imaging apparatus.

Further features of the present invention will become apparent from the following description of exemplary embodiments with reference to the attached drawings.

### BRIEF DESCRIPTION OF DRAWINGS

FIG. 1 is a function block diagram of a computation apparatus according to an embodiment mode.

FIG. 2 is a schematic diagram for describing an X-ray imaging system according to the embodiment mode.

FIG. 3 is a flow chart of an imaging procedure and a computation processing procedure performed by the X-ray imaging system according to the embodiment mode.

FIG. 4A is a schematic diagram for describing a first embodiment.

FIG. 4B is a schematic diagram for describing the first embodiment.

FIG. 4C is a schematic diagram for describing the first embodiment.

FIG. 4D is a schematic diagram for describing the first embodiment.

FIG. 4E is a schematic diagram for describing the first embodiment.

FIG. 4F is a schematic diagram for describing the first embodiment.

FIG. 4G is a schematic diagram for describing the first embodiment.

FIG. 4H is a schematic diagram for describing the first embodiment.

FIG. 5 is a schematic diagram for describing a third embodiment.

### DESCRIPTION OF EMBODIMENTS

According to PTL 1, the insufficient information based only on the absorption image is complemented by the phase image as described above, so that the visibility of the image is improved.

On the other hand, a signal in a surrounding area fades away because of an influence from an area where a signal is intense in the phase image or the absorption image, and an area having a low visibility of the image may be generated. According to the method proposed in PTL 1, the influence from the area where the signal is intense is not alleviated, and the area having the insufficient visibility of the image may be generated.

In view of the above, according to the present embodiment mode, a computation apparatus with which the decrease in the visibility of the image caused by the influence of the surrounding signal can be alleviated, a computation method, a program, and an X-ray imaging system will be described. Hereinafter, the embodiment mode of the present invention will be described in detail with reference to the accompanying drawings.

In the respective drawings, a same member is assigned with a same reference sign, and a duplicated description will be omitted.

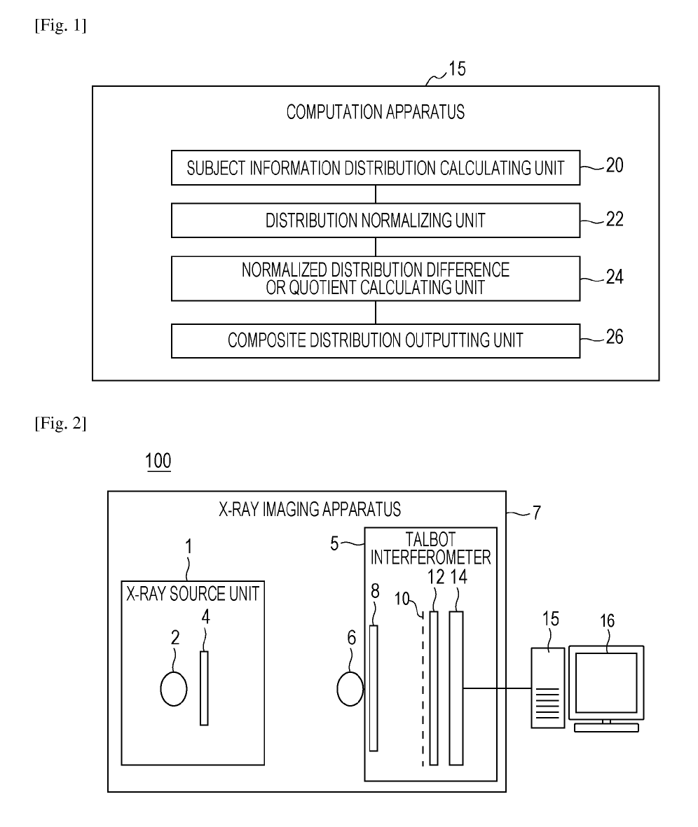

FIG. 1 is a function block diagram of a computation apparatus according to the present embodiment mode. A computation apparatus 15 according to the present embodiment mode includes a unit (distribution normalizing unit) 22 configured to normalize distributions to be combined with each other and a unit (normalized distribution difference or quotient calculating unit) 24 configured to calculate a difference or quotient of the normalized distributions to obtain a composite distribution. The distributions for the composite include two or more distributions including a distribution of absorption information of a subject, a distribution of phase information of the subject, and a distribution of scattering information of the subject. These distributions are calculated by a unit (subject information distribution calculating unit) 20 that is provided to the computation apparatus 15 and configured to calculate information of the subject by using a projection image of the subject based on X-ray. The absorption information for each coordinate is referred to as distribution of the absorption information, the phase information for each coordinate is referred to as distribution of the phase information, and the scattering information for each coordinate is referred to as distribution of the scattering information. The computation apparatus 15 may receive these distributions from an external computation apparatus, a storage apparatus, a storage medium, or the like instead of the calculation by the subject information distribution calculating unit 20.

The distribution normalizing unit 22 normalizes a part or all of values of these distributions to normalize the distributions. The normalized distribution difference or quotient calculating unit 24 configured to obtain the composite distribution subtracts or divides the mutual normalized distributions and calculates the difference or quotient of the distributions to combine the distributions with each other. The composite distribution refers to a distribution calculated by the normalized distribution difference or quotient calculating unit 24.

Three distributions may be combined with each other. In that case, a distribution obtained through the subtraction or division of two of the three distributions and the remaining distribution may be subjected to the subtraction or division. At this time, the subtraction of the two distributions may be conducted, and the calculated distribution and the remaining distribution may be subjected to the subtraction, or the subtraction of the two distributions may be conducted, and the calculated distribution and the remaining distribution may be subjected to the division. Similarly, the division of the two distributions may be conducted, and the calculated distribution and the remaining distribution may be subjected to the subtraction, or the division of the two distributions may be conducted, and the calculated distribution and the remaining distribution may be subjected to the division.

The information of the composite distribution calculated by the normalized distribution difference or quotient calculating unit 24 configured to obtain the composite distribution is sent to a unit (composite distribution outputting unit) 26 configured to output the information of the composite distribution. The composite distribution outputting unit 26 then outputs the information of the composite distribution to an external part of the computation apparatus 15.

The computation apparatus 15 having the above-described functions can be composed, for example, of a computer including a computation unit provided with a calculator such as a CPU, a main storage unit provided with a volatile memory such as a RAM, and an auxiliary storage unit provided with a non-volatile memory such as an HDD. The functions illustrated in FIG. 1 are realized while a program stored in the auxiliary storage unit is loaded into the main storage unit and executed by the computation unit. However, this configuration is merely an example, and the configuration of the computation apparatus 15 is not limited to this. For example, the program may be supplied to the computation apparatus 15 via a network or various storage media.

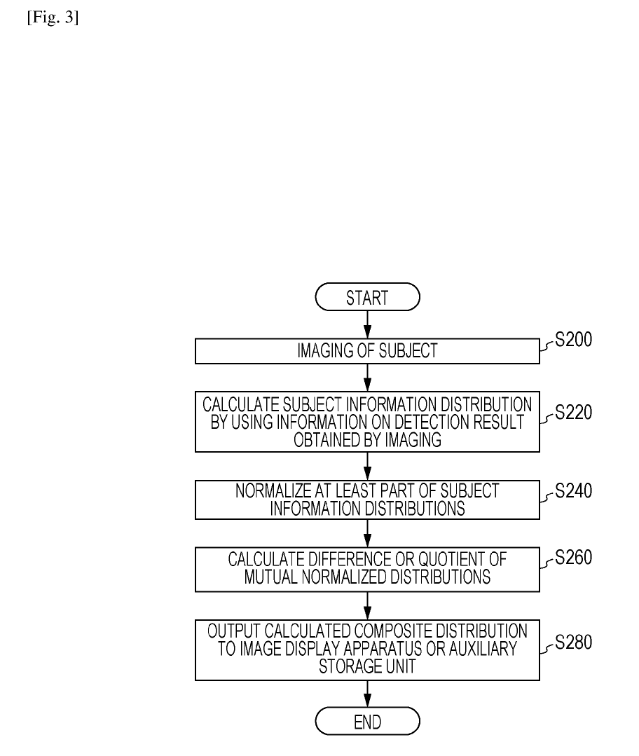

Hereinafter, an X-ray imaging system 100 including the above-described computation apparatus 15 will be described. FIG. 2 is a schematic diagram of the X-ray imaging system 100 according to the present embodiment mode. The X-ray imaging system 100 includes an X-ray imaging apparatus 7, the computation apparatus 15 configured to calculate the information of the subject on the basis of the imaging result of the X-ray imaging apparatus 7, and an image display apparatus 16 configured to display an image based on the calculation result of the computation apparatus 15.

The X-ray imaging apparatus 7 includes an X-ray source unit 1 and a Talbot interferometer 5 configured to perform imaging of the subject by way of X-rays from the X-ray source unit 1.

The X-ray source unit 1 includes an X-ray source 2 and a source grating 4 configured to divide X-rays from the X-ray source 2 and improve a spatial coherence. In case of a two-dimensional grating having periodicity in two directions where a diffraction grating 8 and a shield grating 12 provided in the Talbot interferometer 5 intersect with each other, since the X-rays are to have the spatial coherence in the two directions, the source grating 4 also uses the two-dimensional grating. On the other hand, in case of a one-dimensional grating where the diffraction grating 8 and the shield grating 12 have the periodicity in one direction, since it suffices if the X-rays are to have the spatial coherence in the one direction, the source grating 4 can use the one-dimensional grating. Two of the one-dimensional gratings may be combined with each other and used instead of the two-dimensional grating. According to the present embodiment mode, the source grating 4 is used since the generation area of the X-rays from the X-ray source 2 is large and the X-rays do not have the spatial coherence to such an extent that the diffraction grating 8 can form the interference pattern at the position of the diffraction grating 8, but the source grating 4 may not be used if the X-ray spatial coherence is sufficient. In the present specification, the X-ray refers to an electromagnetic wave having 2 keV or higher but 100 keV or lower.

The Talbot interferometer 5 includes the diffraction grating 8 that diffracts the X-rays output from the X-ray source unit 1, the shield grating 12 that shields a part of the X-rays diffracted by the diffraction grating 8, and a detector 14 configured to detect the X-rays that have passed through the shield grating 12. The diffraction grating 8 and the shield grating 12 may be the one-dimensional grating or may also be the two-dimensional grating. In a case where an imaging apparatus that can obtain the spatially differentiated information (for example, an imaging apparatus that uses a shearing interference) is used, it becomes easier to obtain the information differentiated in the two directions if the two-dimensional grating is used.

When the X-rays output from the X-ray source 2 are diffracted by the diffraction grating 8, an interference pattern called self-image on which a shape of the diffraction grating 8 is reflected appears at a particular distance called Talbot distance. When a subject 6 is arranged between the X-ray source 2 and the diffraction grating 8 or between the diffraction grating 8 and the shield grating 12, the phase of the X-rays is shifted by the subject 6, and the self-image has information on the phase change of the subject 6. The shield grating 12 that shields a part of the X-rays is arranged at a location where the self-image is formed, that is, at the Talbot distance from the diffraction grating 8. In a case where the cycles for the self-image and the shield grating 12 vary from each other or the periodic directions are shifted from each other, moire is generated on the basis of a combination of the self-image and the shield grating 12. This moire is also one of the interference patterns. This moire is imaged by the detector 14 as a projection image of the subject. According to the present embodiment mode, the case has been described in which the image of the moire is imaged, but if the spatial resolution of the detector 14 is high to such an extent that the pattern of the self-image can directly be detected, the self-image may also directly be imaged without using the shield grating 12. In this case, the self-image at a time when the subject 6 is arranged between the X-ray source 2 and the detector 14 is used as the projection image of the subject 6. The cycle of the moire may be shorter or longer than a length of a side of the projection image. No moire is generated in a case where the periodicity of the self-image and the shield grating 12 are equal to each other and the periodic directions are also matched with each other, but the pattern obtained at this time is also dealt with as moire having an infinite periodicity in the present specification.

The X-ray imaging apparatus 7 may also perform the imaging based on a phase shift method. A detail of the phase shift method is omitted since the method is generally widely used, but the method includes relatively moving the self-image and the shield grating 12 to shift the phase of the moire and imaging plural moires where the phases are mutually shifted. It is possible to calculate the information of the subject from the periodic pattern for each pixel created by combining corresponding pixel intensities in the moires by using the thus obtained plural moires.

A bright field image may be imaged by adjusting the positions of the self-image and the shield grating 12 so that the periodicity and the periodic directions of the self-image and the shield grating 12 are matched with each other and a bright section of the self-image is formed on a transmission part of the shield grating 12. Similarly, a dark field image may be imaged by adjusting the position of the self-image and the shield grating 12 so that a dark section of the self-image is formed on the transmission part of the shield grating 12. The bright field image includes much absorption information of the subject 6, and the dark field image includes much scattering information of the subject 6. Therefore, the bright field image or the dark field image may be imaged in accordance with a choice on the information of the subject to be calculated by the computation apparatus 15.

As described above, the computation apparatus 15 includes the subject information distribution calculating unit 20, the distribution normalizing unit 22, the normalized distribution difference or quotient calculating unit 24 configured to obtain the composite distribution, and the composite distribution outputting unit 26.

The subject information distribution calculating unit 20 uses the projection image of the subject 6 based on the X-rays to calculate the distribution of the information of the subject 6. The moire is analyzed to calculate the distribution of the information of the subject 6 in the projection image imaged by the Talbot interferometer 5. The distribution of the absorption amount of the X-rays by the subject 6 is calculated from an average intensity of the moire. The distribution of the phase shift amount of the X-rays by the subject 6 is calculated in a spatially differentiated state from the phase of the moire, and the scattering intensity of the X-rays by the subject 6 is calculated from the visibility of the moire. The distribution of the absorption amount, the distribution of the spatially differentiated shift amount (differentiated phase shift amount), and the distribution of the scattering intensity thus calculated may spatially be differentiated or integrated, or may be subjected to a filter to perform a computation of alleviating the noise. For example, it is possible to calculate the distribution of the phase shift amount by the subject 6 by spatially differentiating the distribution of the differentiated phase shift amount. The distribution of the absorption amount, the distribution of the differentiated phase shift amount, and the distribution calculated on the basis of the distribution of the scattering intensity and those distributions are referred to as distribution of the absorption information, distribution of the phase information, and distribution of the scattering information.

Even when all the distribution of the absorption information, the distribution of the phase information, and the distribution of the scattering information are not calculated, it suffices if at least two of the distributions are calculated.

Although any calculation methods for these distributions may basically be employed, a method using Fourier transform or the above-described phase shift method is generally used in a case where the distribution of the information of the subject is calculated from the projection image imaged by using the Talbot interferometer 5. The distribution of the scattering information may be calculated from the above-described dark field image, and the distribution of the absorption information may be calculated from the bright field image.

The distribution normalizing unit 22 normalizes the values of the distributions to be combined with each other. According to this, it is possible to normalize a grayscale of the image on the basis of the distributions to be combined with each other.

The distribution normalizing unit 22 performs the normalization so that the densities of the images at a part desired to be erased at the time of the combining are close to each other. To realize that situation, the normalization is carried out in the distributions to be mutually combined so that the values corresponding to the spatial coordinates at the part desired to be erased are close to each other. The normalization may be carried out only on the value corresponding to the image at the part desired to be erased and the value corresponding to the surrounding image or may be carried out on the entirety. The number of the parts desired to be erased may be one or more. According the embodiments of the present invention and the present specification, a normalization for setting the values corresponding to certain spatial coordinates are set to be the same as each other is also included in the normalization for setting the values corresponding to the certain spatial coordinates to be close to each other.

With the above-described normalization, when the difference or quotient of the normalized distributions is calculated, it is possible to eliminate or reduce the relative difference of the signals at the normalized common area. It is noted that, according to the embodiments of the present invention and the present specification, the erasing means that the relative difference of the signals is eliminated or reduced to decrease the concentration.

When the normalization is carried out so that the values corresponding to the spatial coordinates at the part desired to be erased are close to each other as described above, the density at the part desired to be erased also in the image based on the composite distribution can be decreased, and it is therefore possible to increase the visibility of the image.

The normalization on the values of the distributions refers to a change of the values of the distributions on the basis of a certain rule. A certain value may be added to the values of the distributions, or the values of the distributions may be multiplied by a certain value for the method for the change. The value added or multiplied with respect to the values of the distributions may also be changed. With the normalization on the values of the distributions, the grayscale of the image based on the distribution also changes. The normalization on all the values of the distributions so that the values at the certain coordinates become identical to each other does not mean the change of the values of the distributions so that the values at all the coordinates of the distributions to be mutually combined become identical to each other. For example, a calculation where all the values of the distributions are multiplied by a predetermined value or a function so that the values at the certain coordinates become identical to each other is called normalization on all the values of the distributions so that the values at the certain coordinates become identical to each other.

The normalized distribution difference or quotient calculating unit 24 configured to obtain the composite distribution calculates a difference or quotient of the mutual normalized distributions to calculate the composite distribution.

The composite distribution outputting unit 26 outputs the information of the composite distribution to the auxiliary storage unit of the computation apparatus 15 or the image display apparatus 16. When the information of the composite distribution is output to the auxiliary storage unit of the computation apparatus 15, the auxiliary storage unit stores the information of the composite distribution.

Among the distributions to be combined with each other, that is, the distributions at least a part of which is normalized by the distribution normalizing unit 22 and used by the normalized distribution difference or quotient calculating unit 24 configured to obtain the composite distribution, the scattering information image may be used for one of the distributions. It is possible to display the information related to the fine internal structure of the subject 6 by using the distribution of the scattering information.

In a case where the distribution of the scattering information is used for one of the distributions for the composite, the distribution of the phase information may be used for the other distribution. The distribution of the phase shift amount of the X-rays by the subject 6 is obtained in the spatially differentiated state (the distribution of the differentiated phase shift amount) in a case where the differential interferometer such as the Talbot interferometer 5 is used. The differentiated phase shift amount generally takes a high value at the contour of the subject 6. The contour of the subject 6 refers to individual contours of the components constituting the subject 6. In a case where the contour is erased, the surrounding image where the normalization is conducted means a surrounding image that does not include the component to which the contour belongs. On the other hand, the scattering amount also takes a high value inside the subject 6 and at the contour of the subject 6. Therefore, among the scattering information distribution and the phase information distribution, the values at the parts corresponding to the contour of the subject 6 are normalized to calculate the difference or quotient, so that it is possible to effectively erase the information on the contour of the subject 6 included in the scattering information distribution and the phase information distribution. As a result, the composite distribution includes much information related to the fine internal structure of the subject 6. For that reason, the information related to the fine internal structure of the subject 6 can effectively be drawn out in the image based on the composite distribution. In a case where an interferometer other than the differential interferometer is used, for example, the distribution of the (not-differentiated) phase shift amount is calculated by the analysis on the periodic pattern, but the obtained distribution of the phase shift amount may be differentiated to calculate the distribution of the differentiated phase shift amount. The distribution of the (not-differentiated) phase shift amount obtained through the integration of the distribution of the differentiated phase shift amount obtained by the differential interferometer or the distribution of the (not-differentiated) phase shift amount obtained by the interferometer other than the differential interferometer may also be combined with the distribution of the scattering information as the distribution of the phase information. A distribution of a root mean square of the differentiated phase shift amount may be combined with the distribution of the scattering information as the distribution of the phase information. Alternatively, a distribution obtained by applying filter processing on the distribution of the (not-differentiated) phase information in a wave number space (the filtered distribution of the absorption information) may be combined with the scattering information as the distribution of the phase information. However, to effectively erase the information on the contour of the subject 6 included in the distribution of the scattering information, the distribution of the differentiated phase shift amount is preferably used instead of the distribution of the (not-differentiated) phase shift amount.

In a case where the distribution of the scattering information is used for one of the distributions for the composite, the distribution of the absorption information may be used for the other distribution. An area where the value is particularly high in the distribution of the scattering information corresponds to an area where the visibility of the periodic pattern is particularly low. Since it is difficult to conduct an analysis on the periodic pattern in the area where the visibility is particularly low, it is difficult to conduct the calculation for the phase information, and an error generated in the distribution of the phase information may be high in some cases. On the other hand, the absorption information is hardly affected by an influence of the visibility of the periodic pattern. For that reason, by combining the distribution of the scattering information with the distribution of the absorption information, it is possible to obtain the information on the contour of the subject 6 even in the area where the visibility of the periodic pattern is low. To effectively erase the information of the edge of the component of the subject 6 from the distribution of the scattering information, the distribution where the X-ray absorption amount by the subject 6 is spatially differentiated (the distribution of the differentiated absorption amount) or the distribution obtained by applying the filter processing on the distribution of the absorption information in the wave number space (the filtered distribution of the absorption information) is preferably used to calculate a difference or quotient with respect to the distribution of the scattering information. Among the scattering information distribution and the absorption information distribution, the values at the parts corresponding to the contour of the subject 6 are normalized to calculate the difference or quotient, so that the information on the contour of the subject 6 included in the scattering information distribution and the absorption information distribution can effectively erased. As a result, the composite distribution includes much information related to the fine internal structure of the subject 6. For that reason, the information related to the fine internal structure of the subject 6 can effectively be drawn out in the image based on the composite distribution.

The distribution of the phase information may be combined with the distribution of the absorption information instead of using the distribution of the scattering information for one of the distributions for the composite. To effectively erase the information of the edge of the component of the subject 6 from the distribution of the phase information, the distribution where the X-ray absorption amount by the subject 6 is spatially differentiated (the distribution of the differentiated absorption amount) is preferably used similarly as in the effective erasing of the information of the edge from the distribution of the scattering information. With the composite with the distribution of the absorption information, the information of the subject 6 on an inner side of the edge of the component of can also be erased from the distribution of the phase information. With these configurations, the information related to the phase shift of the subject 6 can effectively be drawn in the image based on the composite distribution.

The distribution of the scattering information, the distribution of the phase information, and the distribution of the absorption information may be calculated from the result of the imaging of the subject 6 by using a contrast medium. A case where the subject 6 is an animal will be described as an example.

In a case where the subject 6 is an animal, generally, a difference of a tendency of the grayscale is not large between the components in organs except for bones in the distribution of the information of the subject. For that reason, information on the component desired to be remained may also be lost by calculating the difference or quotient by the mutual distributions of the information of the subject. The subject 6 may be composed of a material having a small interaction with the X-rays depending on an imaging site. If the interaction with the X-rays is small, a difference of the values in the distribution of the information of the subject is small. Therefore, the grayscale difference of the image based on the information of the subject is small, and the visibility may be low without change. The tendency of the grayscale can be changed in at least two of the distribution of the absorption information, the distribution of the phase information, and the distribution of the scattering information through an administration of the contrast medium. According to this, since the difference of the values in the composite distribution can be increased, the contrast in the image based on the composite distribution becomes larger, and the visibility can be increased. For example, in a case where the contrast medium including a material where the energy of the X-rays used in the X-ray imaging system 100 is equivalent to an absorption edge is used, the contrast medium generates a difference having a high value in the distribution of the absorption information as compared with the distribution of the phase information. These images based on the composite distribution have a larger contrast than the image based on the composite distribution calculated by using the distribution of the phase information calculated from the periodic pattern imaged without using the contrast medium and the distribution of the absorption information, and therefore the visibility is high.

A contrast medium including micro bubbles may be used for the contrast medium. The micro bubbles are composed of a spherical material containing gaseous matters having a diameter of several micrometers to several hundred micrometers. Since the micro bubbles increase the scattering of the X-rays, the visibility of the periodic pattern is decreased. As a result, the micro bubbles increase the contrast in the image based on the scattering information distribution. The absorption of the X-rays in the micro bubbles is low. When the composite distribution is calculated, for example, by using the absorption information distribution and the scattering information distribution, the image based on the composite distribution becomes an image where the distribution of the X-ray scattering amount generated by a concentration gradient of the micro bubbles is emphasized.

The image display apparatus 16 displays the image based on the composite distribution on the basis of the calculation result of the computation apparatus 15. According to the present specification and the embodiments of the present invention, the image based on the composite distribution refers to an image where the information of the composite distribution is arranged while following the coordinates. An image where the contrast is adjusted, noise is removed, or annotation information is added with respect to the image based on the composite distribution is also regarded as the image based on the composite distribution.

The image display apparatus 16 may display the other information. For example, an imaging condition may be displayed, or each of the absorption information image, the phase information image, and the scattering information image may be displayed.

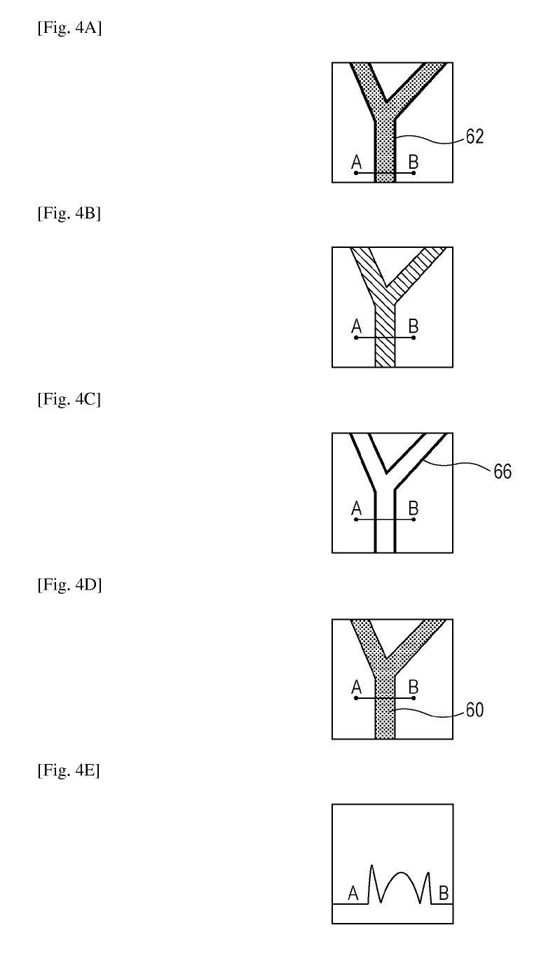

FIG. 3 is a flow chart of an imaging procedure and a computation processing procedure performed by the X-ray imaging system 100 according to the present embodiment mode.

The X-ray imaging system 100 first images the subject 6 by the X-ray imaging apparatus 7 (S200). The information on the detection result of the X-rays obtained through the imaging is transmitted to the computation apparatus 15 and used for various computation processing in the computation apparatus 15. The computation apparatus 15 uses the transmitted information to calculate the distribution of the information of the subject in the subject information distribution calculating unit 20 that is provided to the computation apparatus 15 (S220) and normalizes at least a part of the distributions of the information of the subject in the distribution normalizing unit 22 (S240). The composite distribution is calculated by subtracting or dividing the mutual normalized distributions by the normalized distribution difference or quotient calculating unit 24 configured to obtain the composite distribution (S260), and the calculated composite distribution is output to an image display apparatus 16 or the auxiliary storage unit by the composite distribution outputting unit 26 (S280).

The X-ray imaging apparatus 7 images the projection image of the subject 6. The projection image may include a periodic pattern irrespective of the presence or absence of the subject 6. The calculation for the distribution of the information of the subject is facilitated with the presence of the periodic pattern. This is because the phase and the intensity of the periodic pattern are changed depending on the presence or absence of the subject 6, and the distribution of the information of the subject can be calculated by analyzing the periodic pattern.

The cycle of the periodic pattern may be shorter or longer than a length of one side of the projection image. The periodic pattern can also be configured by combining the plural projection images with each other irrespective of the length of the cycle of the periodic pattern. In a case where the cycle of the periodic pattern is sufficiently shorter than the length of one side of the projection image and is more than three times longer than the length of one side of the pixel, the distribution of the information of the subject can be calculated from the one projection image. When the distributions of the information of the subject to be combined with each other are both calculated from the one projection image, the distribution of the information of the subject can be calculated at a same frame rate as a data transfer frame rate from the detector 14 to the computation apparatus 15, and it is also possible to create a moving image with a smooth movement.

For the method of imaging the projection image having the periodic pattern, a Talbot interference method, a method using multi-pinholes or multi-slits, or a crystalline interference method may be used. When the Talbot interference method is used, the periodic pattern can be generated by multicolor X-rays, and also the sensitivity to the phase information of the subject 6 is high, so that it is possible to calculate the information of the subject having a high contrast and a satisfactory phase sensitivity. The absorption information, the scattering information, and the phase information are easily separated among the information of the subject. With regard to the multi-pinholes or the multi-slits, since the cycle of the pinholes or the slits is generally longer than the cycle of the diffraction grating 8 used in the Talbot interferometer 5, a creation of an optical element is facilitated, and the periodic pattern can be generated also by the multicolor X-rays. The crystalline interference method has a high sensitivity to the phase information of the subject 6. According to the method using the multi-pinholes or the multi-slits, a part with which the X-rays are not irradiated may be generated in the subject 6. Although information of the part with which the X-rays are not irradiated is missing, in order that that the subject 6 and the X-ray imaging apparatus 7 are changed, the information can be complemented while one is scanned with respect to the other.

Hereinafter, specific embodiments of the embodiment mode will be described.

### First Embodiment

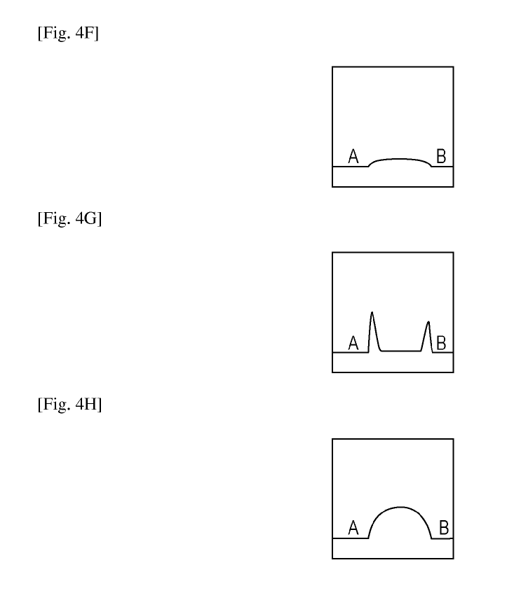

According to a first embodiment, a more specific embodiment of the embodiment mode will be described by using FIG. 2 and FIGS. 4A to 4H.

A configuration of the X-ray imaging system 100 according to the present embodiment is as illustrated in FIG. 2. The X-ray source 2 is provided with a molybdenum target that can generate characteristic X-rays having the energy at 17.5 keV. The X-rays used in the Talbot interference method may be almost homogeneous X-rays where the spectrum is sharp like the characteristic X-rays or may also be multicolor X-rays where the spectrum is wide like bremsstrahlung X-rays. The source grating 4 has a mesh structure, and a setting of lengthwise and crosswise pitches of the mesh at 22 micrometers and a diameter of an opening at 8 micrometers is used. The diffraction grating 8 uses a phase grating where two areas having a phase modulation difference at pi are arranged in a checker board manner. Cycles in lengthwise and crosswise directions are set as 12 micrometers. The shield grating 12 has a mesh structure, and an opening section and a width of a light shielding section have a relationship of 1:1. Cycles in lengthwise and crosswise directions are set as 8.23 micrometers. The source grating 4, the diffraction grating 8, and the shield grating 12 are arranged in the stated order from an upstream side of the X-rays output from the X-ray source 2. A distance between the source grating 4 and the diffraction grating 8 is set as 936 mm, and a distance between the diffraction grating 8 and the shield grating 12 is set as 348 mm. With this arrangement, the bright sections of the interference pattern formed by the X-rays from the source grating 4 at the respective openings mutually enhances the X-ray intensities. The shield grating 12 is overlapped on the interference pattern, and the shield grating 12 is rotated in an in-plane direction, so that a moire pattern in which bright points are arranged in a reticular pattern is generated. The detector 14 is arranged on a downstream side of the shield grating 12. A distance between the detector 14 and the shield grating 12 is preferably short as much as possible. Since an intensity of the interference pattern is the highest at a position having a distance at the Talbot length from the diffraction grating 8, the distance between the diffraction grating 8 and the detector 14 is preferably closer to the Talbot length. Substrate surfaces of the detector 14 and the respective gratings (the source grating 4, the diffraction grating 8, and the shield grating 12) are preferably vertical to an optical axis of the X-rays from the X-ray source 2. The optical axis of the X-rays in the present specification is an axis connecting a center of the X-ray source 2 and a center of an X-ray irradiation range of the detector 14. A rotation angle of the shield grating 12 is adjusted, and a moire pattern having a cycle for four pixels provided to the detector 14 is generated no the detector 14. While this moire pattern is set as the periodic pattern, the composite distribution is calculated in the computation processing procedure, and the image based on the composite distribution is created.

The imaging procedure and the computation processing procedure performed by the X-ray imaging system 100 according to the present embodiment will be described.

According to the present embodiment, the branched blood vessels and the surrounding tissues are used as the subject 6, and the information of the surrounding of the contour is erased from the image based on the distribution of the scattering information, so that the visibility of the information related to the fine internal structure of the scattering information is increased. For that reason, the composite distribution is calculated by calculating a difference between the distribution of the scattering information and the distribution indicating the information on the contour. According to the present embodiment, the distribution indicating the information on the contour of the subject 6 is calculated from the distribution of the absorption amount.

The X-ray imaging system 100 performs the imaging procedure by the X-ray imaging apparatus 7. First, a moire pattern in a state where the subject 6 is absent is detected by the detector 14. Next, the subject 6 to which the contrast medium containing the micro bubbles is administered is arranged at a position between the source grating 4 and the diffraction grating 8 and also close to the diffraction grating 8, and the moire formed by the X-rays that receive the modulation by the subject 6 is detected. A detection result detected at this time is used as the information of the projection image of the subject 6. A detection result of the moire detected when the subject 6 is not arranged is used as the information of the projection image in the absence of the subject 6. The information of the projection image of the subject 6 and the information of the projection image in the absence of the subject 6 are transmitted from the detector 14 to the main storage unit in the computation apparatus 15.

The subject information distribution calculating unit 20 uses the information on the detection result of the moire transmitted to the main storage unit to perform the calculation for the distribution of the information of the subject. According to the present embodiment, the distribution of the scattering information and the distribution of the absorption information are calculated as the distribution of the information of the subject. The distribution of the scattering information and the distribution of the absorption information are calculated by using the Fourier transform method. A method of calculating the distribution of the scattering information and the distribution of the absorption information by using the Fourier transform method will be described.

First, a wave number space spectrum of the moire pattern is calculated by applying Fourier transform on each of the information of the projection image of the subject 6 and the information of the projection image that does not include the subject 6. A distribution of the absorption intensity is calculated from an intensity of a zero-order peak among the calculated wave number space spectra, and a distribution of the scattering intensity is calculated form an intensity ratio of a first-order peak with respect to the zero-order peak. Next, a relative distribution between the distribution of the information of the subject calculated from the information of the projection image that does not include the subject 6 and the distribution of the information of the subject calculated from the information of the projection image of the subject 6 is calculated. When the projection image in the absence of the subject 6 is used in this manner, it is possible to eliminate influences from a thickness irregularity of the diffraction grating 8, a luminance irregularity of the X-rays, or the like.

When the two-dimensional grating is used as in the present embodiment, the distribution of the scattering intensity is calculated with regard to the orthogonal two directions. FIG. 4A illustrates a distribution obtained by calculating a root mean square of the distributions in these two directions. According to the present embodiment, this distribution is used as the distribution of the scattering information. FIG. 4E illustrates a signal intensity distribution on a straight line A-B in FIG. 4A. A distribution where the contour information and the contrast medium information are overlapped with each other is prepared.

According to the present embodiment, to effectively erase the information on the contour from the distribution of the scattering information, the absorption amount distribution is differentiated in the orthogonal two directions, and a distribution obtained by calculating a root mean square of the calculated distributions in the two directions is used as the distribution of the absorption information according to the present embodiment. FIG. 4B illustrates the absorption amount distribution, and FIG. 4C illustrates a distribution obtained by differentiate the absorption amount distribution and calculating a root mean square. FIG. 4F illustrates a signal intensity distribution on a straight line A-B in FIG. 4B, and FIG. 4G illustrates a signal intensity distribution on a straight line A-B in FIG. 4C. Since little distribution exists in the concentration of the contrast medium information in the absorption information, the contour information is dominant in the distribution obtained by calculating the root mean square.

The distribution of the spatially differentiated shift amount can be calculated from the phase of the first-order peak among the above-described wave number space spectra although the distribution is not used and is therefore not calculated according to the present embodiment. When the two-dimensional grating is used as in the present embodiment, the distribution of the differentiated phase shift amount is also calculated in the orthogonal two directions. The distribution of the differentiated phase shift amount is integrated in the orthogonal two directions while a certain point in the distribution of the differentiated phase shift amount is set as a reference, so that a distribution where the (not-differentiated) phase shift amount of the subject 6 is drawn out is calculated. The thus calculated distribution of the (not-differentiated) phase shift amount may be used as the distribution of the phase information, and the distribution of the differentiated phase shift amount may be used as the distribution of the phase information. Which one of the distributions is used as the distribution of the phase information can appropriately be decided depending on which part of the subject 6 is observed.

Next, the distribution normalizing unit 22 normalizes the value of the distribution of the scattering information and the value of the distribution of the absorption information. This normalization is conducted in such a manner that a contrast difference between a boundary scattering unit 62 of the distribution of the scattering information and the background becomes the same as a contrast difference between an absorption contour section 66 of the distribution of the absorption information and the background, and also, the value of the boundary scattering unit 62 of the distribution of the scattering information becomes the same as the value of the absorption contour section 66 of the distribution of the absorption information. The boundary scattering unit 62 in the distribution of the scattering information is equivalent to a contour.

In a case where the normalization is conducted while the value of the distribution of the absorption information is adjusted in accordance with the value of the distribution of the scattering information, the distribution of the scattering information is the distribution calculated by the subject information distribution calculating unit 20 as it is. However, the distribution of the scattering information is regarded as the reference for adjusting the value of the distribution of the absorption information, and according to the present specification, the value of the distribution of the scattering information and the value of the distribution of the absorption information are both normalized.

Next, a difference between the normalized distribution of the scattering information and the normalized distribution of the absorption information is calculated by the normalized distribution difference or quotient calculating unit 24 configured to obtain the composite distribution. The difference between the mutual distributions is calculated by obtaining a difference between the value of the normalized distribution of the scattering information and the value of the normalized distribution of the absorption information for each coordinate. According to this, the contour information is erased from the distribution of the scattering information, and the composite distribution where the scattering by the contrast medium is dominant is calculated. FIG. 4D illustrates the image based on the composite distribution. FIG. 4H illustrates a signal intensity distribution on a straight line A-B of FIG. 4D. With this composite distribution, the visibility of a fine internal structure 60 is improved as compared with the distribution of the scattering information (FIG. 4A and FIG. 4E).

The information of the composite distribution is then transmitted to the image display apparatus 16 by the composite distribution outputting unit 26, and the image based on this information is displayed on the image display apparatus 16. The information of the composite distribution is also transmitted to the auxiliary storage unit of the computation apparatus 15 by the composite distribution outputting unit 26, and the auxiliary storage unit stores the received information.

According to the present embodiment, the plural distributions of the information of the subject are calculated from the moire pattern obtained from the single detection, and the mutual distributions are subtracted to calculate the composite distribution. For that reason, it is possible to suppress the generation of an artifact caused by the time difference in the calculation for the composite distribution. The artifact caused by the time difference refers to an artifact generated when the mutual distributions of the information of the subject 6 derived from the detection results at different timings for the detection is conducted are combined with each other.

The detection for obtaining the information of the projection image in the absence of the subject 6 may or may not be conducted for every imaging of the subject 6. For example, the detection for obtaining the information of the projection image in the absence of the subject 6 is conducted in advance, and a detection result thereof may be stored in the auxiliary storage unit or the like. In this case, even if the diffraction grating 8 of the Talbot interferometer 5 is moved and the moire patterns move in tandem in a period between the detection for obtaining the information of the projection image in the absence of the subject 6 and the detection for obtaining the information of the projection image of the subject 6, for example, the movement amount can be obtained by an inverse calculation from the distribution and corrected. Since one composite distribution can be calculated from the single detection, in a case where a flat panel detector at 30 frames per second, for example, is used as the detector 14, it is possible to create the composite distribution at a speed of 30 frames per second. The composite distribution outputting unit 26 transmits the composite distribution in continuous frames to the image display apparatus 16, and the image display apparatus 16 that has received the composite distribution displays the image, so that the image based on the composite distribution can be displayed as a moving image.

According to the present embodiment, the information of the surrounding of the contour is erased from the image based on the distribution of the scattering information by calculating the difference of the mutual normalized distributions, but the quotient of the mutual normalized distributions may be calculated. According to the present embodiment, a case will simply be described in which the absorption amount distribution is differentiated, and the distribution of the scattering information (FIG. 4A) is divided by the distribution (FIG. 4C) obtained by calculating the root mean square instead of the subtraction of the mutual normalized distributions. The absorption amount distribution is differentiated, the distribution (a type of the differentiated absorption amount distribution) obtained by calculating the root mean square and the distribution of the scattering information (FIG. 4A) are normalized and divided, the value in the area corresponding to the contour becomes low (to be set as 1), and the value in the other area becomes high. Therefore, since the value in the area corresponding to the contour can be set to be relatively low, the visibility of the fine internal structure 60 is more improved than the distribution of the scattering information (FIG. 4A).

### Second Embodiment

According to a second embodiment, more specific another embodiment of the embodiment mode will be described.

The second embodiment is different from the first embodiment in that the cycle of the moire pattern is longer than the length of one side of the projection image. Accordingly, to carry out the phase shift method, the subject information distribution calculating unit 20 is different in the imaging procedure and the computation processing procedure. The other configurations are similar to the first embodiment, and a description thereof will be omitted.

The phase shift method includes shifting the phase of the X-rays to detect the periodic pattern by plural times and calculating a change in the phase of the X-rays by the subject 6 from the detection result. To shift the phase of the X-rays, a method of shifting the phase of the moire by changing the relative positions of the self-image and the shield grating 12 is used in the X-ray Talbot interferometer.

The imaging procedure conducted according to the present embodiment will be described.

According to the present embodiment, first, the subject 6 is not arranged between the X-ray source 2 and the detector 14, and the phase is shifted to detect the X-rays by 16 times and obtain reference data for the 16 times. The phase shift is caused by moving the position of the source grating 4 by 5.5 micrometers each in the mesh periodic directions (two directions) for every detection. For example, after the position of the source grating 4 is moved by 5.5 micrometers each in a first periodic direction to detect the X-rays by four times, the position of the source grating 4 is moved by 5.5 micrometers in a second periodic direction to detect the X-rays, and then the position of the source grating 4 is moved by 5.5 micrometers each again in the first periodic direction to detect the X-rays by three times. Thus, the detection is conducted by eight times. Similarly, for the remaining eight times, the movement of the source grating 4 and the detection are conducted, so that the detection can be conducted by 16 times. In this manner, the movement by 5.5 micrometers each is conducted by four times in the two periodic directions, and the reference data for the 16 times is obtained by moving the source grating 4 in a 4*4 matrix. Next, the subject 6 to which the contrast medium containing the micro bubbles is administered is arranged at a position between the source grating 4 and the diffraction grating 8 and also close to the diffraction grating 8, the data of the projection image for 16 times is obtained through a method similar to the method in the case where the subject 6 is not arranged. The reference data and the data of the projection image thus obtained are stored in the auxiliary storage unit in the computation apparatus 15.

Next, the subject information distribution calculating unit 20 according to the present embodiment will be described.

Intensity data at the 16 points is obtained for each pixel of the detector 14 in each of the reference data and the projection image data. The periodic pattern for each pixel corresponds to a pattern in which the intensity data at the 16 points for each pixel is arranged in matrix while corresponding to the relative position of the source grating 4. To elaborate, in a case where after the first detection, the movement of the source grating 4 is moved in the first periodic direction, and the detection is conducted for every movement, the detection results for the first to fourth times are arranged in the first periodic direction also in the periodic pattern. The thus calculated periodic pattern for each pixel is subjected to the two-dimensional Fourier transform to calculate a frequency spectrum of the periodic pattern. An absorption amount is calculated from the intensity of the zero-order peak by using the calculated frequency spectrum, and the scattering intensity can be calculated from an intensity ratio of the first-order peak with respect to the zero-order peak. Since the calculation for the absorption intensity and the scattering intensity is conducted for each pixel, it is possible to calculate the distribution of the absorption amount and the distribution of the scattering intensity. Similarly as in the first embodiment, the relative distribution between the distribution of the information of the subject calculated from the information of the projection image that does not include the subject 6 and the distribution of the information of the subject calculated from the information of the projection image of the subject 6 is calculated, so that the influences from the diffraction grating 8 or the luminance irregularity of the X-rays are alleviated. According to the present embodiment too, the distribution obtained while the absorption amount distribution is differentiated to calculate the root mean square as in the first embodiment is used as the distribution obtained while the root mean square of the distribution of the scattering intensity is calculated from the distribution of the absorption information, and the distribution obtained by calculating the distribution of the scattering intensity is used as the distribution of the scattering information. In a case where the phase shift method is conducted too, the spatially differentiated shift amount can be calculated from the phase of the first-order peak.

Similarly as in the first embodiment, the difference between the normalized distribution of the scattering information and the normalized distribution of the absorption information is calculated by the normalized distribution difference or quotient calculating unit 24 by using the calculated distribution of the information of the subject. According to this, the contour information is erased from the distribution of the scattering information, and the composite distribution where the scattering by the contrast medium is dominant is calculated.

According to the present embodiment, the description on the method in a case where the cycle of the moire pattern is longer than the length of one side of the projection image has been described, but a similar method can be employed also in a case where the cycle of the moire pattern is shorter than the length of one side of the projection image. In a case where a modulation transfer function of the detector 14 is low, the cycle of the moire pattern is preferably large. The frame rate of the composite distribution is decreased to 1/16 with respect to the data transfer frame rate of the detector 14, but in a case where the data transfer frame rate of the detector 14 is sufficiently high, a moving image can also be created. According to the present embodiment too, similarly as in the first embodiment, instead of the subtraction by the distributions to be mutually combined, the division of the distributions to be mutually combined may be conducted.

### Third Embodiment

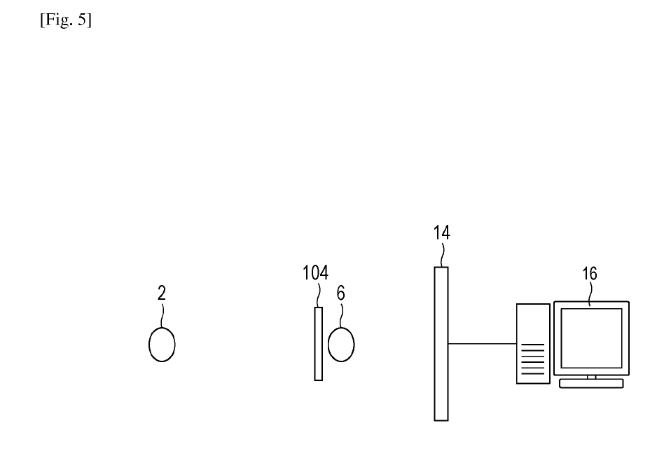

According to a third embodiment, more specific another embodiment of the embodiment mode will be described by using FIG. 5.

The third embodiment is different from the first embodiment in that a method using multi-slits is employed for the method of imaging the projection image having the periodic pattern. Accordingly, the subject information distribution calculating unit 20 is different in the imaging procedure of scanning the relative position between the subject 6 and the multi-slits and the computation processing procedure. The other configurations are similar to the first embodiment, and a description thereof will be omitted.

The X-ray source 2 is provided with a molybdenum target that can generate characteristic X-rays having the energy at 17.5 keV. The X-rays may be almost homogeneous X-rays where the spectrum is sharp like the characteristic X-rays or may also be multicolor X-rays where the spectrum is wide like the bremsstrahlung X-rays. A size of the focus is 100 micrometers. A dividing element 104 has a slit-shaped structure, plural slits are periodically arranged. A setting of a period of the slits at 103 micrometers and a width of an opening at 34 micrometers is used. A pixel pitch of the detector 14 is set as 48 micrometers. The dividing element 104 and the detector 14 are arranged in the stated order from an upstream side of the X-rays output from the X-ray source 2. The subject 6 is arranged on a downstream of the dividing element 104. The X-rays passing through the dividing element 104 are shaped into a sheet having a substantially same width as the opening width of the dividing element 104. When a distance between the X-ray source 2 and the dividing element 104 is set as 800 mm, and a distance between the dividing element 104 and the detector 14 is set as 690 mm, the X-ray beam forms a striped pattern at a pitch of 196 micrometers on the detector 14. That is, a striped pattern having a cycle for four pixels of the pixels provided to the detector 14 is generated on the detector 14. The subject information distribution calculating unit 20 uses the information on the detection result of the striped pattern transmitted to the main storage unit to perform the calculation for the distribution of the information of the subject. According to the present embodiment, the distribution of the scattering information and the distribution of the absorption information are calculated as the distribution of the information of the subject. The distribution of the scattering information and the distribution of the absorption information are calculated by using the Fourier transform method. The method of calculating the distribution of the scattering information and the distribution of the absorption information by using the Fourier transform method is similar to the first embodiment. The dividing element 104 has an opening ratio at ⅓. For that reason, the information of the subject obtained by signal imaging is ⅓ of the total. In view of the above, the imaging while the dividing element 104 is moved by 34.3 micrometers repeated is repeated by three times, and it is possible to obtain the information of all the areas of the subject 6. These pieces of information are spatially rearranged so as not to be in conflict with the position information of the subject 6, and the distribution of the information of the subject is calculated.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-284425, filed Dec. 27, 2012 and No. 2013-240121 filed Nov. 20, 2013, which are hereby incorporated by reference herein in their entirety.

### REFERENCE SIGNS LIST

20 Subject information distribution calculating unit

22 Distribution normalizing unit

24 Normalized distribution difference or quotient calculating unit

26 Composite distribution outputting unit

1. A computation apparatus comprising:
a normalization unit configured to normalize values at least of two of distributions including a distribution of absorption information of a subject, a distribution of phase information of the subject, and a distribution of scattering information of the subject which are calculated by using a projection image of the subject by X-rays; and
a calculation unit configured to calculate a difference or quotient of the normalized two distributions and obtain a composite distribution.

2. The computation apparatus according to claim 1, wherein the normalization unit configured to normalize the at least two distributions normalizes the values of the at least two distributions so that the values corresponding to a same spatial coordinate of at least two of the distribution of the absorption information, the distribution of the phase information, and the distribution of the scattering information are close to each other.

3. The computation apparatus according to claim 1,
wherein the distribution of the absorption information is a distribution of an absorption amount of the X-rays by the subject, a distribution obtained by differentiating the distribution of the absorption amount, a distribution of a root mean square of a value obtained by differentiating the distribution of the absorption amount in two directions, or a distribution obtaining by filtering the distribution of the absorption amount in a wave number space,
wherein the distribution of the phase information is a distribution of a phase shift amount of the X-rays by the subject, a distribution of a differentiated phase shift amount of the X-rays, a distribution of a root mean square of the differentiated phase shift amount, or a distribution obtaining by filtering the distribution of the phase shift among in the wave number space, and
wherein the distribution of the scattering information is a distribution of a scattering intensity of the X-rays by the subject or a distribution of a root mean square of the distribution of the scattering intensity in two directions.

4. The computation apparatus according to claim 1,
wherein the projection image of the subject has a periodic pattern, and
wherein the at least two of the distribution of the absorption information, the distribution of the phase information, and the distribution of the scattering information which are normalized by the normalization unit are calculated through an analysis on the periodic pattern.

5. The computation apparatus according to claim 1, further comprising:
a calculation unit configured to calculate distributions of at least two of the distribution of the absorption information, the distribution of the phase information, and the distribution of the scattering information.

6. The computation apparatus according to claim 1, wherein the normalization unit normalizes values of at least two distributions among a distribution of a section corresponding to a contour of the subject which the distribution of the absorption information has, a distribution of a section corresponding to a contour of the subject which the distribution of the phase information has, and a distribution of a section corresponding to a contour of the subject which the distribution of the scattering information has.

7. The computation apparatus according to claim 1, wherein the normalization unit normalizes a part of the values of the distributions to be normalized.

8. The computation apparatus according to claim 1, wherein the projection image is imaged by an interferometer or a differential interferometer.

9. The computation apparatus according to claim 8, wherein the projection image is imaged by a Talbot interferometer.

10. An X-ray imaging system comprising:
an X-ray imaging apparatus; and
a computation apparatus configured to use a projection image of a subject obtained by the X-ray imaging apparatus to calculate information of the subject, wherein the computation apparatus is the computation apparatus according to claim 1.

11. The X-ray imaging system according to claim 10, further comprising:
an image display apparatus configured to display information based on a calculation result by the computation apparatus,
wherein the image display apparatus displays the image based on the composite distribution.

12. The X-ray imaging system according to claim 10, wherein the X-ray imaging apparatus is a Talbot interferometer.

13. A non-transitory computer-readable medium storing therein a program for causing a computation apparatus to execute:
normalizing values of two of distributions including a distribution of absorption information of a subject, a distribution of phase information of the subject, and a distribution of scattering information of the subject which are calculated by using a projection image of the subject by X-rays; and
calculating a difference or quotient of the normalized two distributions and obtaining a composite distribution.

14. The non-transitory computer-readable medium storing therein the program according to claim 13, wherein the computation apparatus is caused to further execute: displaying the composite distribution.

15. The computation apparatus according to claim 1,
wherein the normalization unit normalizes the distribution of the absorption information and the distribution of the scattering information, and
wherein the calculation unit combines the distribution of the absorption information and the distribution of the scattering information with each other to obtain the composite distribution.

16. The computation apparatus according to claim 15, wherein the distribution of the absorption information is a distribution obtained by spatially differentiating an absorption amount of the X-rays by the subject or a distribution obtained by filtering the absorption amount of the X-rays in a wave number space.

17. The computation apparatus according to claim 1,
wherein the normalization unit normalizes the distribution of the absorption information and the distribution of the phase information,
wherein the distribution of the absorption information is a distribution obtained by spatially differentiating an absorption amount of the X-rays by the subject, and
wherein the calculation unit combines the distribution of the absorption information and the distribution of the phase information with each other to obtain the composite distribution.

18. The computation apparatus according to claim 1,
wherein the projection image of the subject is a projection image obtained by administrating a contrast medium to the subject and picking up an image of the subject,
wherein the normalization unit normalizes at least the distribution of the scattering information, and
wherein the calculation unit combines at least one of the distribution of the absorption information and the distribution of the phase information, with the distribution of the scattering information.

19. The computation apparatus according to claim 1, wherein the calculation unit combines the three distributions including the distribution of the absorption information of the subject, the distribution of the phase information of the subject, and the distribution of the scattering information of the subject with one another to obtain the composite distribution.
